(19) United States
(12) Patent Application Publication
(10) Pub. No.: US 2014/0230045 A1
(43) Pub. Date: Aug. 14, 2014

(54) GRAPHICAL OBJECT-BASED USER AUTHENTICATION FOR COMPUTERIZED DEVICES

(71) Applicant: LG CNS CO., LTD., (US)

(72) Inventors: Won Young Choi, Seoul (KR); Un Sang Lee, Gyeonggi-do (KR); Un Hi Jeong, Seoul (KR); Soo Sung Moon, Seoul (KR); In Tae Song, Seoul (KR); Ji Seong Song, Seoul (KR)

(73) Assignee: LG CNS CO., LTD., Seoul (KR)

(21) Appl. No.: 13/767,032

(22) Filed: Feb. 14, 2013

(51) Int. Cl. G06F 21/31

(52) U.S. Cl. CPC G06F 21/31
USPC 726/19

(57) ABSTRACT

Embodiments of the present invention provide an approach for graphical object-based user authentication for computerized/electronic devices (e.g., touch screen devices, cell phones, computerized tablets, handheld devices, etc.). In a typical embodiment, when a user attempts to access a computerized device, the user will be presented with a plurality of graphical objects (e.g., icons, shortcuts, shapes, patterns, etc.). The user may then select a particular graphical object (e.g., via a touch screen) and perform one or more user interactions therewith. Such user interactions may include (but are not limited to) physical manipulations of the graphical object, and/or audio/video manipulations made in conjunction with the selection of the graphical object. The graphical object(s) selected and the user interaction performed will then be compared to previously stored authentication information to determine whether the access to the computerized device should be granted to the user.

### TECHNICAL FIELD

In general, embodiments of the present invention relate to access control for computerized/electronic devices. Specifically, embodiments of the present invention relate to graphical object-based user authentication for computerized devices (e.g., handheld devices, etc.)

### BACKGROUND OF THE INVENTION

As computerized/electronic devices become more pervasive, the need to provide device security grows. Specifically, with the widespread use of portable devices (e.g., smart phones, tablets, etc.), user's personal information and/or private data is increasingly at risk. Many such devices allow for a device lock/password-based access control system whereby a user may input a string of letters and/or numbers to access the device. Such strings may be input using the device's keypad, keyboard, and/or touch screen. Unfortunately, the current password-based system may be highly insecure as passwords are often easy to guess and/or decode.

U.S. Pat. No. 5,430,827 discloses an approach whereby passwords are spoken by users and stored as speech models in a database. The database also contains a plurality of reference voice (RV) speech models based on speech inputs by various persons. Each RV speech model includes characters, digits, or phrases comprising user assigned passwords.

U.S. Pat. No. 5,559,961 discloses an approach whereby graphical password arrangement displays a predetermined graphical image and requires a user to “touch” predetermined areas of the image in a predetermined sequence, as a means of entering a password.

U.S. Pat. No. 6,973,575 discloses a system and method for providing a password to a user using voice recognition technology. The user's voice signature is captured and stored in order to identify the user. When the user forgets or otherwise loses a password needed to log into a computer system, he telephones a password reset system.

U.S. Pat. No. 7,243,239 discloses methods, systems, devices and/or storage media for passwords. An exemplary method tiles an image, associates an index with each tile, and optionally determines offsets for select tiles.

U.S. Pat. No. 7,539,874 discloses a method, system, and whereby program defeating unauthorized keystroke logging during password entry are provided. Secure password entry is facilitated by displaying a password prompt comprising a changing stream of random characters, where a particular character within the stream of random characters is displayed at a visibly detectable higher frequency.

U.S. Pat. No. 7,734,930 discloses methods, systems, devices and/or storage media for passwords. An exemplary method tiles an image, associates an index with each tile and optionally determines offsets for select tiles.

Unfortunately, the previous approaches fail to address the issues of the related art.

### SUMMARY

In general, embodiments of the present invention provide an approach for graphical object-based user authentication for computerized/electronic devices (e.g., touch screen devices, cell phones, computerized tablets, handheld devices, etc.). In a typical embodiment, when a user attempts to access a computerized device (device), the user will be presented with a plurality of graphical objects (e.g., icons, shortcuts, shapes, patterns, etc.). The user may then select a particular graphical object (e.g., via a touch screen) and perform one or more user interactions therewith. Such user interactions may include (but are not limited to) physical manipulations (e.g., swipes, taps, multiple taps, taps and holds, any combination thereof, etc.) of the graphical object, and/or audio/video manipulations (e.g., voice prompts, facial recognition, any combination thereof, etc.) made in conjunction with the selection of the graphical object. The graphical object(s) selected and the user interaction performed will then be compared to previously stored authentication information (e.g., graphical objects and user corresponding interactions) to determine whether the access to the computerized device should be granted to the user.

A first aspect of the present invention provides a computer-implemented method for graphical object-based access control of computerized devices, comprising: receiving a designation of a set of authentication credentials for accessing a computerized device, the set of authentication credentials comprising at least one graphical object selected from among a plurality of graphical objects and at least one user interaction with the at least one graphical object; storing the set of authentication credentials in a computer storage device; receiving a selection of a particular graphical object from the set of graphical objects from a proposed user; and determining whether the selection of the particular graphical object and any particular user interaction with the particular graphical object match the set of authentication credentials stored in the computer storage device.

A second aspect of the present invention provides a system for graphical object-based access control of computerized devices, comprising: a memory medium comprising instructions; a bus coupled to the memory medium; and a processor coupled to the bus that when executing the instructions causes the system to: receive a designation of a set of authentication credentials for accessing a computerized device, the set of authentication credentials comprising at least one graphical object selected from among a plurality of graphical objects and at least one user interaction with the at least one graphical object; store the set of authentication credentials in a computer storage device; receive a selection of a particular graphical object from the set of graphical objects from a proposed user; and determine whether the selection of the particular graphical object and any particular user interaction with the particular graphical object match the set of authentication credentials stored in the computer storage device.

A third aspect of the present invention provides a computer program product for graphical object-based access control of computerized devices, the computer program product comprising a computer readable storage media, and program instructions stored on the computer readable storage media, to: receive a designation of a set of authentication credentials for accessing a computerized device, the set of authentication credentials comprising at least one graphical object selected from among a plurality of graphical objects and at least one user interaction with the at least one graphical object; store the set of authentication credentials in a computer storage device; receive a selection of a particular graphical object from the set of graphical objects from a proposed user; and determine whether the selection of the particular graphical object and any particular user interaction with the particular graphical object match the set of authentication credentials stored in the computer storage device.

A fourth aspect of the present invention provides a method for deploying a system graphical object-based access control of computerized devices, comprising: providing a computer infrastructure being operable to: receive a designation of a set of authentication credentials for accessing a computerized device, the set of authentication credentials comprising at least one graphical object selected from among a plurality of graphical objects and at least one user interaction with the at least one graphical object; store the set of authentication credentials in a computer storage device; receive a selection of a particular graphical object from the set of graphical objects from a proposed user; and determine whether the selection of the particular graphical object and any particular user interaction with the particular graphical object match the set of authentication credentials stored in the computer storage device.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a system diagram according to an embodiment of the present invention.

FIG. 3 depicts an illustrative computerized/electronic device according to an embodiment of the present invention.

FIG. 4 depicts a method flow diagram according to an embodiment of the present invention.

FIG. 5 depicts another method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Embodiments of the present invention provide an approach for graphical object-based user authentication for computerized/electronic devices (e.g., touch screen devices, cell phones, computerized tablets, handheld devices, etc.). In a typical embodiment, when a user attempts to access a computerized device (device), the user will be presented with a plurality of graphical objects (e.g., icons, shortcuts, shapes, patterns, etc.). The user may then select a particular graphical object (e.g., via a touch screen) and perform one or more user interactions therewith. Such user interactions may include (but are not limited to) physical manipulations (e.g., swipes, taps, multiple taps, taps and holds, any combination thereof, etc.) of the graphical object, and/or audio/video manipulations (e.g., voice prompts, facial recognition, any combination thereof, etc.) made in conjunction with the selection of the graphical object. The graphical object(s) selected and the user interaction performed will then be compared to previously stored authentication information (e.g., graphical objects and user corresponding interactions) to determine whether the access to the computerized device should be granted to the user.

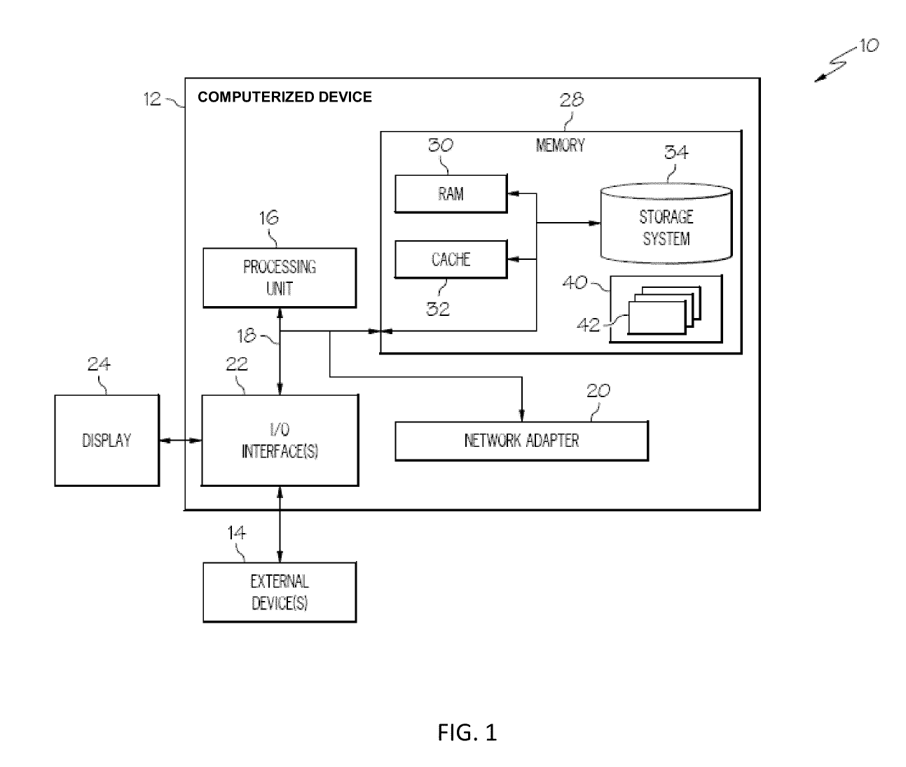

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computerized device 12, which is operational with numerous other general purpose or special purpose computing system environments or configurations. Examples of well-known computing systems, environments, and/or configurations that may be suitable for use with computerized device 12 include, but are not limited to, personal computer systems, server computer systems, thin clients, thick clients, hand-held or laptop devices, computerized tables, smart phones, cellular phones, mobile devices, global positioning systems (GPS), GPS-enabled devices, multiprocessor systems, microprocessor-based systems, set top boxes, programmable consumer electronics, network PCs, minicomputer systems, mainframe computer systems, and distributed computing environments that include any of the above systems or devices, and the like.

Computerized device 12 may be described in the general context of computer system-executable instructions, such as program modules, being executed by a computer system. Generally, program modules may include routines, programs, objects, components, logic, data structures, and so on, which perform particular tasks or implement particular abstract data types. Computerized device 12 may be practiced in distributed computing environments where tasks are performed by remote processing devices that are linked through a communications network. In a distributed computing environment, program modules may be located in both local and remote computer system storage media including memory storage devices.

As shown in FIG. 1, computerized device 12 in computing node 10 is shown in the form of a general-purpose computing device. The components of computerized device 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computerized device 12 typically includes a variety of computer system readable media. Such media may be any available media that is accessible by computerized device 12, and it includes both volatile and non-volatile media, removable and non-removable media.

System memory 28 can include computer system readable media in the form of volatile memory, such as random access memory (RAM) 30 and/or cache memory 32. Computerized device 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Access control program/utility 40, having a set (at least one) of program modules 42, may be stored in memory 28 by way of example, and not limitation, as well as an operating system, one or more application programs, other program modules, and program data. In general, access control 40 performs the function of the present invention as described herein. Each of the operating system, one or more application programs, other program modules, and program data or some combination thereof, may include an implementation of a networking environment. Program modules 42 generally carry out the functions and/or methodologies of embodiments of the invention as described herein.

Computerized device 12 may also communicate with one or more external devices 14 such as a keyboard, a pointing device, a display 24, etc.; one or more devices that enable a consumer to interact with computerized device 12; and/or any devices (e.g., network card, modem, etc.) that enable computerized device 12 to communicate with one or more other computing devices. Such communication can occur via I/O interfaces 22. Still yet, computerized device 12 can communicate with one or more networks such as a local area network (LAN), a general wide area network (WAN), and/or a public network (e.g., the Internet) via network adapter 20. As depicted, network adapter 20 communicates with the other components of computerized device 12 via bus 18. It should be understood that although not shown, other hardware and/or software components could be used in conjunction with computerized device 12. Examples include, but are not limited to: microcode, device drivers, redundant processing units, external disk drive arrays, RAID systems, tape drives, and data archival storage systems, etc.

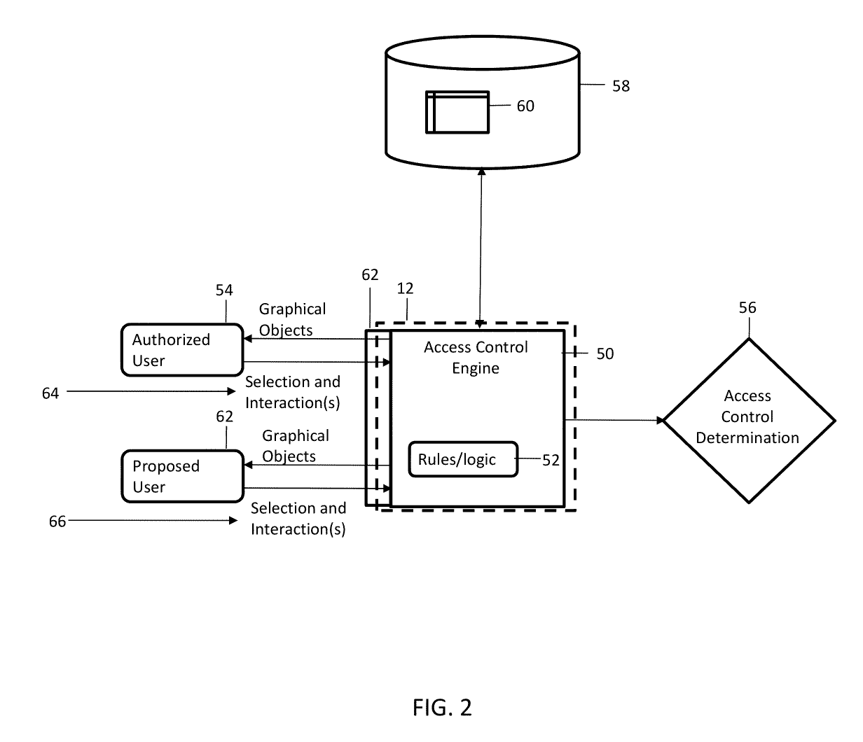

Referring now to FIG. 2, a system diagram describing the functionality discussed herein according to an embodiment of the present invention is shown. It is understood that the teachings recited herein may be practiced within any type of networked computing environment (e.g., a cloud computing environment). A computerized device 12, which can be implemented as either a stand-alone computer system, or as a networked computer system is shown in FIG. 2. In the event the teachings recited herein are practiced in a networked computing environment, each client need not have an access control engine (engine 50). Rather, engine 50 could be loaded on a server (e.g., payment processing server) or server-capable device that communicates (e.g., wirelessly) with the clients to provide graphical object-based access control functionality hereunder. Regardless, as depicted, engine 50 is shown within computerized device 12. In general, engine 50 can be implemented as program/utility 40 on computer system 12 of FIG. 1 and can enable the functions recited herein. As further shown, engine 50 (in one embodiment) comprises a rules and/or computational engine that processes a set (at least one) of rules/logic 52 and/or provides graphical object-based access control functionality hereunder.

Along these lines, engine 50 may perform multiple functions similar to a general-purpose computer. Specifically, among other functions, engine 50 may (among other things): display a plurality of graphical objects on a display 62 of a computerized device 12 for the establishment of a set of authentication credentials 64 by an authorized user of the computerized device 12; receive a designation/establishment of the set of authentication credentials 64 for accessing the computerized device 12 (e.g., from authorized user 54), the set of authentication credentials 64 comprising at least one graphical object (e.g., a graphical icon, a graphical shortcut, a graphical shape, or a graphical pattern) selected from among the plurality of graphical objects and at least one user interaction with the at least one graphical object; store the set of authentication credentials 64 in a computer storage device 58 (e.g., in a table 60 or the like that associates authentication credentials 64 with computerized device 12 (and/or authorized users); display a set of graphical objects on a display 62 of the computerized device 12 in response to an attempt to access the computerized device 12 by a proposed user 62; receive a selection of a particular graphical object(s) from the set of graphical objects from the proposed user; receive a particular user interaction(s) (e.g., a physical manipulation(s), a media-based interaction(s) such as sound/voice/image/video, etc.) with the particular graphical object(s) from the proposed user (shown collectively as submitted/attempted credentials 66); determine whether the selection of the particular graphical object(s) and the particular user interaction(s) with the particular graphical object(s) match the set of authentication credentials 64 stored in the computer storage device 58 (e.g., cross-check against table 60); make an access control determination 56 for the proposed user 62 based on the access control determination 56; grant access to the computerized device 12 if particular graphical object(s) selected and the particular user interaction(s) match the set of authentication credentials 64; and/or prompt the proposed user to input a password (e.g., as an additional layer of security) after the submitted credentials 66 have been validated.

### ILLUSTRATIVE EXAMPLE

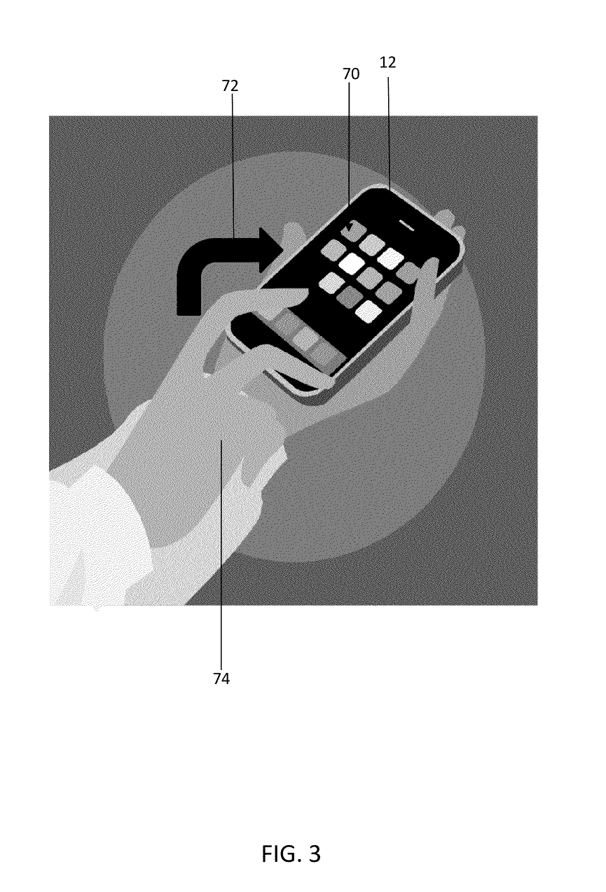

Referring now to FIG. 3, an illustrative example is shown. As depicted, computerized device 12 comprises a display on which graphical object 70 are displayed. A user 74 may select one or more of the graphical objects and perform some type of user interaction 72 in conjunction therewith. As indicated above, such user interaction(s) may comprise one or more of the following a physical manipulation of the graphical object(s), a media-based interaction (e.g., voice, sound, image, video, etc.), or any combination thereof. The physical manipulation of the graphical object(s) may include a movement of a part or a portion of the graphical object(s). For example, you may find a certain key of a plurality of keys, and then you may put the key that you find into a door lock. The physical manipulation of the graphical object(s) and the media-based interaction may be only the user's concrete action. Regardless, the selected graphical object(s) and associated user interaction(s) will be compared against authentication credentials previously provided/stored. If a match is determined to exist, computerized device 12 will be unlocked and access to user 74 may be granted.

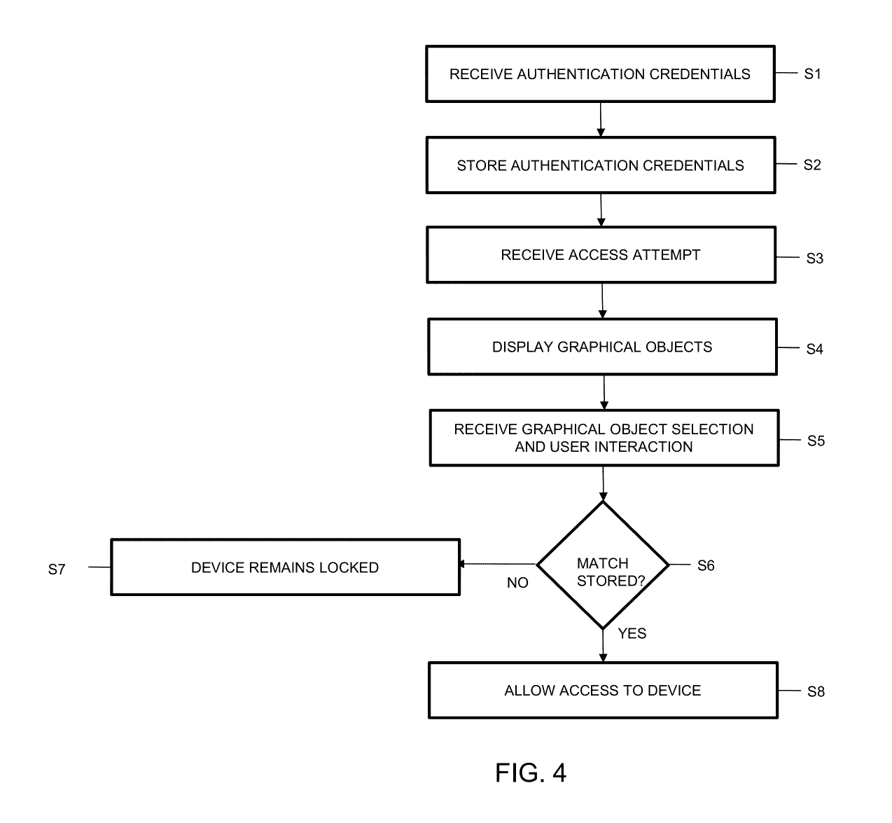

Referring now to FIG. 4, a method flow diagram outlining this process is shown. In general, the flow diagram of FIG. 4 may be implemented by program 40 of FIG. 1 and/or engine 50 of FIG. 2. Regardless, as depicted in FIG. 4, authentication credentials are received in step S1, and stored in a computer storage device or the like in step S2. In step S3, an access attempt is received and processed. In step S4, graphical objects are displayed. In step S5, a selection of at least one graphical object and at least one user interaction made in conjunction therewith are received (i.e., “submitted credentials”). In step S6, it is determined whether the submitted credentials match the authentication credentials previously stored. If not, the device remains locked in step S7. If so, access to the device may be allowed in step S8 (or the user may then be promoted to input additional credentials such as a password or the like).

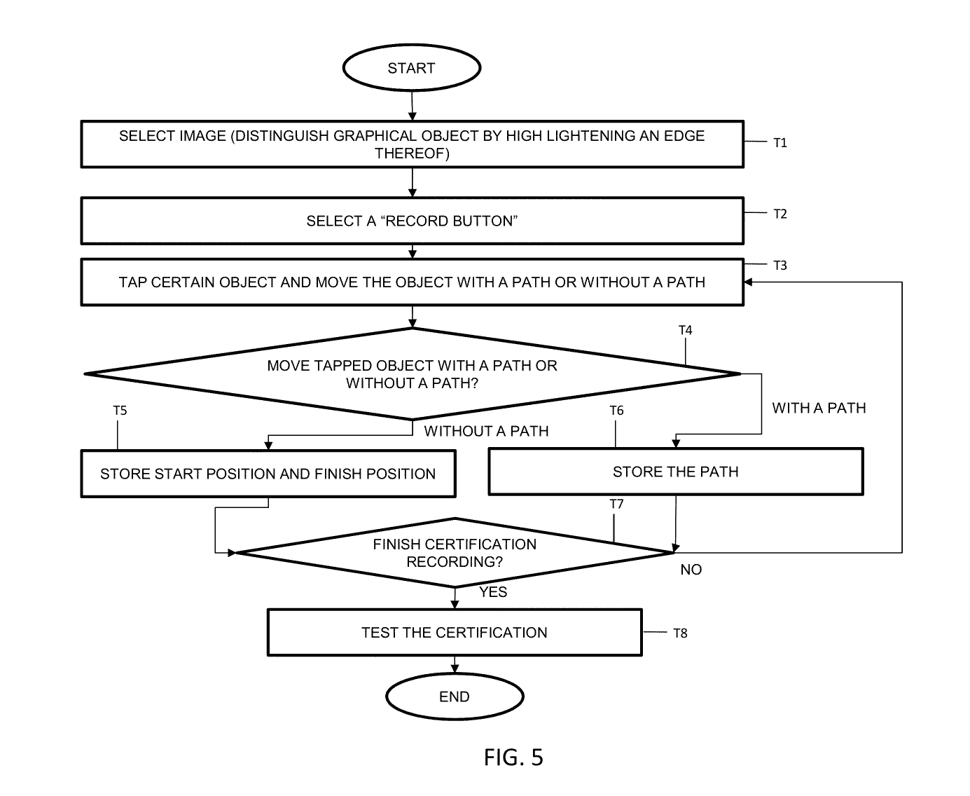

Referring now to FIG. 5, another method flow diagram according to an embodiment of the present invention is shown. As depicted, in step T1, an image is selected and distinguished (e.g., by highlighting an edge thereof). In step T2, a record button is selected. In step T3, a certain/particular object may be “tapped” and moved with a path or without a path. In step T4, it is determined whether the tapped object was moved with a path or without a path. If the tapped object is moved without a path, the start and finish positions of the movement are stored in step T5. If the tapped object is moved with a path, the path is stored in step T6. In either event, in step T7, it is determined whether the certification of the recording is complete/finished. If not, the process returns to step T3. If so, the certification is tested in step T8 before the process is ended.

While shown and described herein as a graphical object-based authentication solution, it is understood that the invention further provides various alternative embodiments. For example, in one embodiment, the invention provides a computer-readable/useable medium that includes computer program code to enable a computer infrastructure to provide graphical object-based authentication as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide graphical object-based authentication functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for graphical object-based authentication. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for graphical object-based access control of computerized devices, comprising:
receiving a designation of a set of authentication credentials for accessing a computerized device, the set of authentication credentials comprising at least one graphical object selected from among a plurality of graphical objects and at least one user interaction with the at least one graphical object;
storing the set of authentication credentials in a computer storage device;
receiving a selection of a particular graphical object from the set of graphical objects from a proposed user; and
determining whether the selection of the particular graphical object and any particular user interaction with the particular graphical object match the set of authentication credentials stored in the computer storage device.

2. The computer-implemented method of claim 1, the graphical object being selected from a group consisting of: a graphical icon, a graphical shortcut, a graphical shape, or a graphical pattern.

3. The computer-implemented method of claim 1, further comprising receiving a particular user interaction with the particular graphical object from the proposed user.

4. The computer-implemented method of claim 1, the particular user interaction comprising at least one of the following: a physical manipulation of the particular graphical object as displayed on the display, or a sound-based interaction with the particular graphical object.

5. The computer-implemented method of claim 4, wherein the physical manipulation is to move a part or a portion of the particular graphical object with a path.

6. The computer-implemented method of claim 4, wherein the physical manipulation is to move a part or a portion of the particular graphical object without a path.

7. The computer-implemented method of claim 6, further comprising storing a start position and a finish position of the movement of the part or the portion of the particular graphical object.

8. The computer-implemented method of claim 1, further comprising granting access to the computerized device if the particular graphical object selected and the particular user interaction match the set of authentication credentials.

9. The computer-implemented method of claim 1, further comprising prompting the proposed user to input a password.

10. The computer-implemented method of claim 1, the designation of the set of authentication credentials being received from an authorized user of the computerized device.

11. The computer-implemented method of claim 1, the computerized device comprising one of the following: a handheld device or a computerized tablet, and the display of the computerized device comprising an interactive screen.

12. A system for graphical object-based access control of computerized devices, comprising:
a memory medium comprising instructions;
a bus coupled to the memory medium; and
a processor coupled to the bus that when executing the instructions causes the system to:
receive a designation of a set of authentication credentials for accessing a computerized device, the set of authentication credentials comprising at least one graphical object selected from among a plurality of graphical objects and at least one user interaction with the at least one graphical object;
store the set of authentication credentials in a computer storage device;
receive a selection of a particular graphical object from the set of graphical objects from a proposed user; and
determine whether the selection of the particular graphical object and any particular user interaction with the particular graphical object match the set of authentication credentials stored in the computer storage device.

13. The system of claim 12, the memory medium further comprising instructions for causing the system to receive a particular user interaction with the particular graphical object from the proposed user.

14. The system of claim 12, the memory medium further comprising instructions for causing the system to grant access to the computerized device if the particular graphical object selected and the particular user interaction match the set of authentication credentials.

15. The system of claim 12, further comprising prompting the proposed user to input a password.

16. The system of claim 12, the designation of the set of authentication credentials being received from an authorized user of the computerized device.

17. The system of claim 12, the computerized device comprising one of the following: a handheld device or a computerized tablet, and the display of the computerized device comprising an interactive screen.

18. A computer program product for graphical object-based access control of computerized devices, the computer program product comprising a computer readable storage media, and program instructions stored on the computer readable storage media, to:
receive a designation of a set of authentication credentials for accessing a computerized device, the set of authentication credentials comprising at least one graphical object selected from among a plurality of graphical objects and at least one user interaction with the at least one graphical object;
store the set of authentication credentials in a computer storage device;
receive a selection of a particular graphical object from the set of graphical objects from a proposed user; and
determine whether the selection of the particular graphical object and any particular user interaction with the particular graphical object match the set of authentication credentials stored in the computer storage device.

19. The computer program product claim 18, the computer readable storage media further comprising instructions to grant access to the computerized device if the particular graphical object selected and the particular user interaction match the set of authentication credentials.

20. A method for deploying a system graphical object-based access control of computerized devices, comprising:
providing a computer infrastructure being operable to:
receive a designation of a set of authentication credentials for accessing a computerized device, the set of authentication credentials comprising at least one graphical object selected from among a plurality of graphical objects and at least one user interaction with the at least one graphical object;
store the set of authentication credentials in a computer storage device;
receive a selection of a particular graphical object from the set of graphical objects from a proposed user; and
determine whether the selection of the particular graphical object and any particular user interaction with the particular graphical object match the set of authentication credentials stored in the computer storage device.
